(19) United States
(12) Patent Application Publication
(10) Pub. No.: US 2024/0098325 A1
(43) Pub. Date: Mar. 21, 2024

(54) INFORMATION PROCESSING DEVICE

(71) Applicant: NTT DOCOMO, INC., Chiyoda-ku (JP)

(72) Inventors: Kunihiro AIBA, Chiyoda-ku (JP); Souhei ONO, Chiyoda-ku (JP); Taku ITO, Chiyoda-ku (JP)

(73) Assignee: NTT DOCOMO, INC., Chiyoda-ku (JP)

(21) Appl. No.: 18/263,022

(22) PCT Filed: Dec. 17, 2021
(86) PCT No.: PCT/JP2021/046826

§ 371 Date: Jul. 26, 2023

(30) Foreign Application Priority Data
Jan. 29, 2021 (JP) 2021-013141

(51) Int. Cl. H04N 21/258; H04N 21/25

(52) U.S. Cl. CPC H04N 21/25891; H04N 21/252

(57) ABSTRACT

The information processing device 30 includes: an extraction unit 33 for extracting a target user who has used content in a content delivery service providing the content to a user; an acquisition unit 34 for acquiring preference information related to a preference of the target user extracted by the extraction unit 33 and including a plurality of first item values related to a predetermined preference; and a tendency information generation unit 35 for generating tendency information indicating a tendency of the content based on the preference information of the target user acquired by the acquisition unit 34.

### TECHNICAL FIELD

One aspect of the present invention relates to an information processing device.

### BACKGROUND ART

Patent Document 1 describes an information processing device that generates a preference value of a user for each content based on information such as the size of a window displaying the content that is a TV program in a display screen provided in the information processing device used by the user, and stores the generated preference value in association with the content. A meta data such as a score associated with content like the preference value may be used for analysis of content, recommendation of content to a user, or the like.

### CITATION LIST

### Patent Document

[Patent Document 1] Japanese Unexamined Patent Publication No. 2008-172660

### SUMMARY OF INVENTION

### Technical Problem

An electronic commerce site (EC site) provides various services for handling various content such as a service for handling magazines and a service for handling moving images. The content handled in such a service is usually associated with meta data such as the price and genre of the content by the service provider. Such meta data can be utilized for analysis of content, recommendation of content to a user, and the like. However, the type of meta data associated with each content by the service provider usually differs depending on the type of service, the type of content, and the like. In addition, the meta data which is different between content as described above cannot be used as an indicator common to all content. Therefore, there is a demand for a method of giving a unified score to each of a plurality of content beyond the difference in the type of content, the type of service, and the like.

An object of one aspect of the present invention is to provide an information processing device capable of giving a unified score to each of a plurality of content.

### Solution to Problem

An information processing device according to one aspect of the present invention includes: an extraction unit configured to extract a target user that is a user who has used content in a content delivery service providing the content to the user; an acquisition unit configured to acquire preference information related to a preference of the target user extracted by the extraction unit, the preference information including a plurality of item values related to a predetermined preference; and a tendency information generation unit configured to generate tendency information indicating a tendency of the content based on the preference information of the target user acquired by the acquisition unit.

In the information processing device according to one aspect of the present invention, in a content delivery service that provides content to a user, a target user that is a user who has used the content is extracted, preference information related to a preference of the extracted target user and including a plurality of item values related to a predetermined preference is acquired, and tendency information indicating a tendency of the content is generated based on the acquired preference information of the target user. According to the above configuration, the tendency information indicating the tendency of the content is generated by reflecting the plurality of item values related to the preference of the user who has used the content, and thus it is possible to assign a unified score to each of the plurality of content.

### Advantageous Effects of Invention

According to one aspect of the present invention, it is possible to provide an information processing device capable of giving a unified score to each of a plurality of content.

### BRIEF DESCRIPTION OF DRAWINGS

FIG. 1 is a functional block diagram of an information processing system according to the present embodiment.

FIG. 2 is a schematic diagram illustrating a flow of generating tendency information by the information processing device according to the present embodiment.

FIG. 3 is a schematic diagram illustrating an example of a method for generating the first preference estimation model shown in FIG. 1.

FIG. 4 is a schematic diagram showing a flow of acquiring an item value using the first preference estimation model shown in FIG. 1.

FIG. 5 is a schematic diagram illustrating a flow of updating tendency information by the information processing device according to the present embodiment.

FIG. 6 is a flowchart showing tendency information generation process by the information processing device according to the present embodiment.

FIG. 7 is a flowchart showing tendency information update process by the information processing device according to the present embodiment.

FIG. 8 is a diagram illustrating an example of a hardware configuration of the information processing device.

### DESCRIPTION OF EMBODIMENTS

Hereinafter, an embodiment of the present invention will be described in detail with reference to the accompanying drawings. In the description of the drawings, the same or corresponding elements will be denoted by the same reference signs, and redundant description will be omitted.

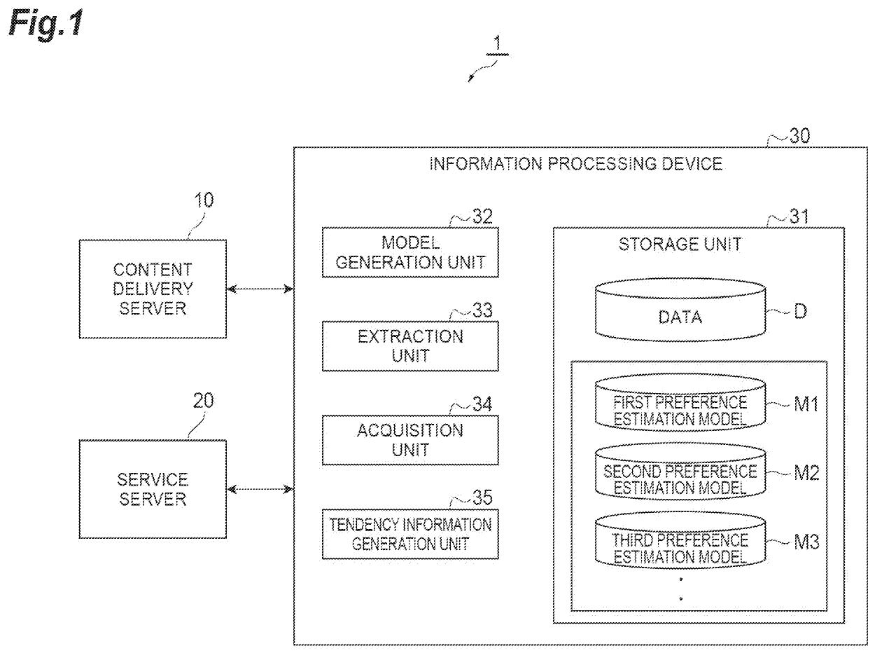

FIG. 1 is a functional block diagram of an information processing system 1 according to the present embodiment. The information processing system 1 is a system for giving a unified score (index) to each of a plurality of content. Specifically, the information processing system 1 generates tendency information indicating a tendency of the content as the score. The information processing system 1 includes a content delivery server 10, a service server 20, and an information processing device 30. In the information processing system 1, transmission and reception of data are possible between the information processing device 30 and the content delivery server 10 and between the information processing device 30 and the service server 20.

The content delivery server 10 is a server that provides a content delivery service. The content delivery service is a predetermined service that provides content to a plurality of users. The content delivery service is operated by a communication provider through a mobile communication network, for example, and provides various content in response to a request from a user. Examples of content include video, music, and electronic books. The content includes content of various genres. Examples of the genre include a genre related to sports (hereinafter simply referred to as “sports”), a genre related to animation (hereinafter simply referred to as “animation”), and a genre related to magazines (electronic books) (hereinafter simply referred to as “magazine”). The content handled by such a content delivery service is associated with a meta data such as the price and genre of the content by the communication provider. The type of meta data associated with content may vary depending on the type of service, the type of content, etc.

The content delivery server 10 manages information (for example, attribute information to be described later) of users who use the content delivery service. For example, each user accesses a content delivery service provided by the content delivery server 10 via a web browser, a dedicated application, or the like. In the content delivery service, for example, a list of a plurality of content is presented to the user.

For example, the content delivery server 10 displays a list of content for recommendation on the user terminal at a timing when each user logs in to the content delivery service. Then, the content delivery server 10 delivers the content selected (purchased) by the user to the user terminal, thereby providing the content to the user.

The content delivery server 10 stores various information including basic information of each user and usage information of a content delivery service by each user. The basic information includes, for example, information capable of uniquely identifying each user (hereinafter referred to as “user identification information”), gender, age, address, occupation, or the like of each user. The usage information of the content delivery service includes, for example, identification information of each user, usage frequency of the content delivery service by each user, information capable of uniquely identifying the content selected by the user (hereinafter referred to as “content identification information”), or the like. Every time a user uses content, the content delivery server 10 stores the user identification information and the content identification information of content used by the user in association with each other. The content delivery server 10 and the information processing device 30 may be configured by the same device.

The service server 20 is a server that provides a service different from the above-described content delivery service (hereinafter referred to as “other service”). The other service is, for example, a service operated by a communication provider via a mobile communication network. The service server 20 stores various kinds of information including basic information of each user and usage information of other services by each user. The usage information of the other service includes, for example, a usage frequency of the other service by the user, a use time of the other service by the user, or the like. Although the number of service servers 20 shown in FIG. 1 is one, the number of other services may be plural. Further, the number of service servers 20 may be plural, and for example, a service server 20 may be provided for each of other services.

The information processing device 30 is a device that generates tendency information of content. As described above, the type of meta data associated with content handled by a content delivery service may differ depending on the type of service, the type of content, and the like. As described above, the meta data that is different between content cannot be used as an indicator (uniform reference) common to all content. Therefore, it is difficult to utilize the meta data set separately between services or between content as described above for analysis of content, recommendation of content to a user, and the like. Therefore, the information processing device 30 generates tendency information that is a unified score for each of a plurality of content beyond the difference in the type of content, the type of service, and the like.

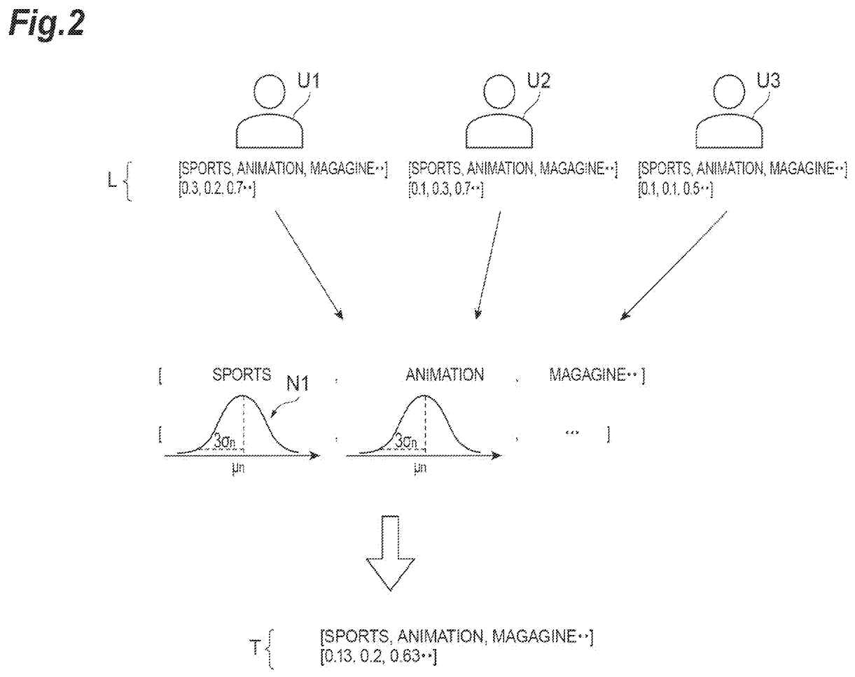

The information processing device 30 generates tendency information for each content. Although the following description focuses on one piece of content, the information processing device 30 performs similar processing on other pieces of content. FIG. 2 is a schematic diagram showing a flow of generating tendency information by the information processing device 30. The information processing device 30 acquires preference information for each target user, who is a user who has used content, and statistically processes the preference information for each target user to generate tendency information of the content.

The preference information is information related to the preference of the user. The preference information includes a plurality of first item values (a plurality of item values) related to a preference. Each first item value is a numerical value indicating a degree of preference of the target user for each of the plurality of genres. The plurality of genres are genres related to content and are determined in advance. In addition, one first item value is associated with one genre. Each first item value takes a value between 0 and 1, for example, and the larger the value, the higher the degree of preference of the target user. As described above, the preference information includes information in which the preference of the target user for each of a plurality of genres is quantified.

FIG. 2 shows an example in which one content of interest is used by three target users U1, U2, and U3. In this case, the information processing device 30 first acquires preference information L of each target user U1, U2, and U3. In the example illustrated in FIG. 2, a plurality of genres related to content including “sports”, “animation”, and “magazine” are determined in advance. For example, focusing on the preference information L of the target user U1, the first item value “0.3” is associated with “sports”, the first item value “0.2” is associated with “animation”, and the first item value “0.7” is associated with “magazine”. In this example, the preference information L of the target user U1 indicates that the target user U1 prefers magazines over sports and animations.

The tendency information is information indicating the tendency of the content. More specifically, the tendency information is information indicating what kind of users tend to use the content. The tendency information includes a statistical value of the degree of preference of the entire target user for each of a plurality of genres as an item value (second item value) for each genre. For example, the second item value of the genre “magazine” included in the tendency information of content that is likely to be used by a user who prefers the genre “magazine” (that is, a user whose first item value of the genre “magazine” is relatively high) is a relatively large value. In this manner, from the second item value of each genre included in tendency information, it is possible to grasp by which user (that is, a user who prefers which genre) the content tends to be used.

In the example illustrated in FIG. 2, the information processing device 30 acquires preference information L for each of target users U1, U2, and U3, and statistically processes the preference information L for each of target users U1, U2, and U3 to generate tendency information T of the content. The tendency information T includes a second item value “0.13” of “sports”, a second item value “0.2” of “animation”, and a second item value “0.63” of “magazine”. That is, in this example, the tendency information T of the content indicates that the content tends to be used (preferred) by users who prefer magazines rather than sports and animations.

Next, a functional configuration of the information processing device 30 will be described. The information processing device 30 includes a storage unit 31, a model generation unit 32, an extraction unit 33, an acquisition unit 34, and a tendency information generation unit 35.

The storage unit 31 stores each piece of information (data D) input from each functional unit. Further, the storage unit 31 stores a plurality of preference estimation models. Note that the storage unit 31 may be configured by a device different from the information processing device 30. For example, the data D may be stored in an external sever capable of communicating with the information processing device 30.

The model generation unit 32 generates a preference estimation model by executing machine learning using training data including attribute information of a user and information indicating a preference of the user. In the present embodiment, the preference estimation model includes preference estimation models (first preference estimation model M1, second preference estimation model M2, third preference estimation model M3, or the like) for each of a plurality of genres. The preference estimation model corresponding to each genre is a model configured to input attribute information of a user and output an estimated value of preference information of the user related to the corresponding genre. The estimated value corresponds to the first item value of the corresponding genre. The model generation unit 32 stores each generated preference estimation model in the storage unit 31.

In this embodiment, the model generation unit 32 generates a preference estimation model for each of a plurality of genres including a first preference estimation model M1, a second preference estimation model M2, and a third preference estimation model M3, as shown in FIG. 1. The first preference estimation model M1 is a model corresponding to the genre “sports”. The second preference estimation model M2 is a model corresponding to the genre “animation”. The third preference estimation model M3 is a model corresponding to the genre “magazine”. Hereinafter, the processing of the model generation unit 32 will be described focusing on the first preference estimation model M1.

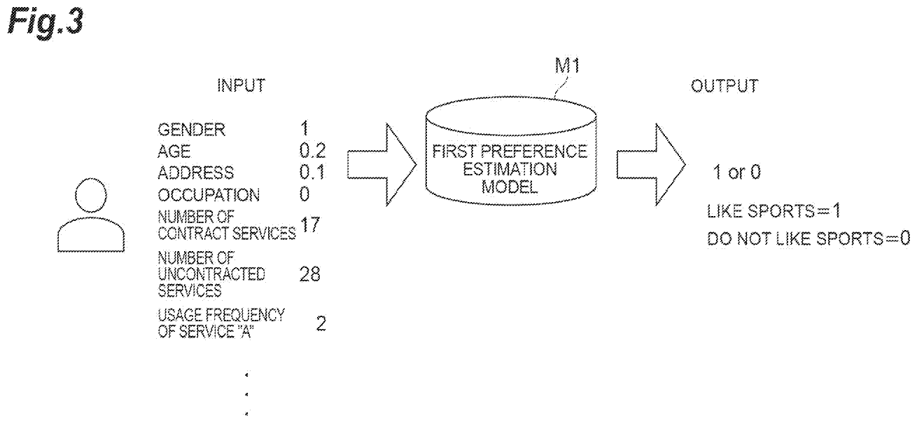

As the machine learning executed by the model generation unit 32, a conventionally known method such as gradient boosting, multiple regression analysis, or a neural network (including deep learning using a multilayer neural network) is used. The preference estimation model generated by the model generation unit 32 is not limited to a particular aspect. An example of a method for generating a preference estimation model by the model generation unit 32 will be described below with reference to the example shown in FIG. 3. FIG. 3 is a diagram schematically showing an example of a method for generating the first preference estimation model M1 (a model corresponding to “sports”) shown in FIG. 1. For example, the model generation unit 32 generates a preference estimation model by performing machine learning using training data including a feature value related to attribute information of the user and an index value (information indicating a preference of the user) indicating whether or not the user likes a genre (here, “sports”). Here, the feature value related to the attribute information of the user corresponds to an input data (explanatory variable) of the preference estimation model, and the index value corresponds to an output data (objective variable) of the preference estimation model.

The attribute information of the user includes basic information of the user and usage information of one or more services used by the user. Examples of basic information include the gender, age, address, and occupation of the user. Examples of the usage information of the user include the number of services with which the user has a contract, the number of services with which the user has no contract, a use frequency of each service of the user, and a use time of each service of the user (for example, an average use time of a service on a daily basis). The services with which the user has a contract include a content delivery service provided by the content delivery server 10 and other services provided by the service server 20 described above. The feature value related to the attribute information of the user may be, for example, a numerical value normalized based on a distribution of a large number of users who use each service as a whole.

The index value is a value that takes “1” when the user likes sports and takes “0” when the user does not like sports. The index value is obtained based on, for example, a data indicating a questionnaire result answered by the user in advance, a data indicating a “favorite genre” selected by the user at the time of activation of an application installed in the user terminal, and the like.

According to the machine learning using the training data, a preference estimation model configured to input a feature value related to attribute information of a user and output preference information of the user for a corresponding genre may be obtained. The output value (the above-described preference information) of the first preference estimation model M1 indicates a possibility (probability) that the user corresponding to the input attribute information likes “sports”. The machine learning executed by the model generation unit 32 is not limited to the above-described method. Also, the type of attribute information input to the preference estimation model is not limited to the above example.

The extraction unit 33 extracts a target user that is a user who has used content in the content delivery service. The extraction unit 33 refers to the usage information of the content delivery service at an arbitrary timing set in advance, for example, and extracts a target user who has used the content. The processes of the extraction unit 33, the acquisition unit 34, and the tendency information generation unit 35 are executed for each content. Hereinafter, these processes will be described by focusing on one content.

The extraction unit 33 extracts a new user as the target user every time the content is used. For example, every time a predetermined period elapses, the extraction unit 33 refers to the usage information of the content delivery service and extracts a new target user who has used the content. The extraction unit 33 outputs information in which the user identification information of the extracted target user is associated with the content identification information of the content to the acquisition unit 34.

The acquisition unit 34 acquires preference information of the target user extracted by the extraction unit 33. For example, by inputting attribute information of the target user to each preference estimation model stored in the storage unit 31, the acquisition unit 34 acquires an output result from each preference estimation model as preference information for each genre of the target user. The acquisition unit 34 acquires, for example, the basic information corresponding to the user identification information of the target user received from the extraction unit 33, the usage information of the content delivery service, and the usage information of other services as attribute information from the content delivery server 10 and the service server 20. Then, the acquisition unit 34 inputs the acquired pieces of information (more specifically, numerical values obtained by normalizing the pieces of information) to the preference estimation models. The acquisition unit 34 acquires preference information for all target users extracted by the extraction unit 33.

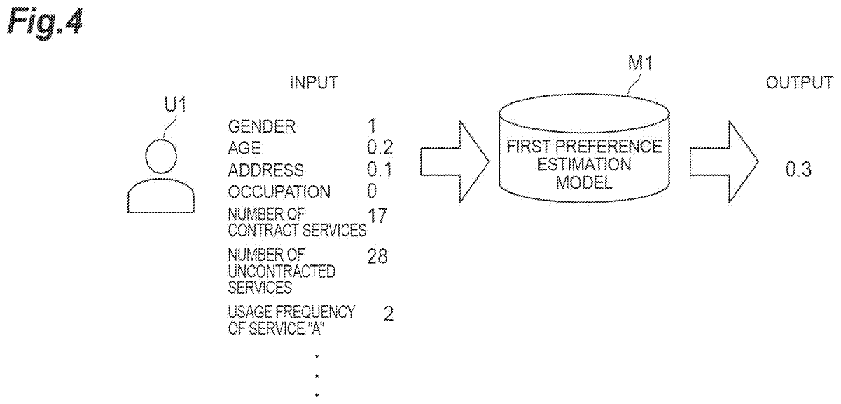

Here, an example of a method of acquiring preference information by the acquisition unit 34 will be described using an example illustrated in FIG. 4. FIG. 4 is a diagram schematically showing a flow of acquiring the first item value of the genre “sports” using the first preference estimation model M1 shown in FIG. 1. The acquisition unit 34 inputs the basic information and the usage information of the target user U1 acquired from the content delivery server 10 and the usage information of the target user U1 acquired from the service server 20 to the first preference estimation model M1. Then, the acquisition unit 34 acquires a first item value (here, “0.1” as an example) corresponding to “sports” as an output result from the first preference estimation model M1. Similarly to the first preference estimation model M1, the acquisition unit 34 acquires output results from other preference estimation models (second preference estimation model M2, third preference estimation model M3, or the like) as first item values corresponding to “animation” and “magazine”. In this way, preference information L of the target user U1 is obtained as in the example shown in FIG. 2. Similarly, the acquisition unit 34 acquires preference information L of the other target users U2 and U3.

When the acquisition unit 34 receives identification information of a new target user from the extraction unit 33, the acquisition unit 34 acquires preference information of the new user. The acquisition unit 34 outputs information in which the acquired preference information of each target user is associated with the identification information of the content received from the extraction unit 33 to the tendency information generation unit 35.

The tendency information generation unit 35 generates tendency information of the content based on the preference information of the target user acquired by the acquisition unit 34. When only one target user is extracted by the extraction unit 33, the tendency information generation unit 35 may directly use the preference information of the target user as tendency information. On the other hand, when a plurality of target users are extracted by the extraction unit 33, the tendency information generation unit 35 may generate tendency information by statistically processing the first item value of each target user for each genre. Hereinafter, a case where a plurality of target users are extracted by the extraction unit 33 will be described. The tendency information generation unit 35 stores, in the storage unit 31, information in which the generated tendency information, content identification information, and statistics (average and variance described later, and the number of all target users) are associated with one another.

Here, a method of generating tendency information by the tendency information generation unit 35 will be described. First, the tendency information generation unit 35 calculates the average and variance of the first item values of each target user received from the acquisition unit 34 for each genre. Then, the tendency information generation unit 35 generates a normal distribution based on the calculated average and variance for each genre. Then, the tendency information generation unit 35 generates a random number based on the normal distribution for each genre, and generates the value of the random number as the second item value of the tendency information. The random number can be generated by a known method.

In the example illustrated in FIG. 2, the target users U1 to U3 who have used the content are extracted by the extraction unit 33, and the preference information L of each of the target users U1 to U3 is acquired by the acquisition unit 34. The tendency information generation unit 35 calculates the average and variance of the first item values (that is, the first item value (=0.3) of the target user U1 , the first item value (=0.1) of the target user U2, and the first item value (=0.1) of the target user U3) corresponding to the “sports” of each of the target users U1 to U3, and generates the normal distribution N1 represented by the calculated average and variance. Then, the tendency information generation unit 35 sets the value (“0.13” in this example) of the random number generated based on the normal distribution N1 as the second item value corresponding to “sports”.

The tendency information generation unit 35 generates second item values corresponding to other genres including “animation” and “magazine” in the same manner as the second item value of “sports”. In this way, the tendency information generation unit 35 generates the tendency information T based on the generated normal distribution N1 of each genre. In this example, since the first item values of “magazine” of target users U1 to U3 are relatively large values, the second item value of “magazine” included in the tendency information T is a value larger than the second item value of “sports” and the second item value of “animation”. That is, the tendency information T indicates that the content is likely to be used by a target user who likes “magazine” (in other words, is preferred by a user who likes “magazine”).

When the tendency information generation unit 35 receives the preference information of the new target user of the content and the identification information of the content from the acquisition unit 34, the tendency information generation unit 35 updates the tendency information of the content based on the preference information of the new target user.

First, the tendency information generation unit 35 acquires, from the storage unit 31, statistics (that is, the average and variance of each genre of the content and the number of all target users who have used the content) corresponding to the identification information of the content of interest (content for which tendency information is to be generated). Then, the tendency information generation unit 35 updates the normal distribution of each genre by using, for example, an average update function and a variance update function. The average update function is a function that outputs an average in consideration of the new target user based on the average calculated so far and each first item value included in the preference information of the new target user. By using the average update function, it is possible to save time and effort for calculation. The variance update function is a function used for the same reason as the average update function. The tendency information generation unit 35 may calculate the average and variance for each genre based on the preference information of all target users including the new target user without using the average update function and the variance update function. The average update function is expressed by the following Expression 1, and the variance update function is expressed by the following Expression 2.

$${μ}_{n + 1} = \frac{1}{n + 1} ( n {μ}_{n} + {x}_{n + 1} ) \qquad ( Expression 1 )$$

$${σ}_{n + 1}^{2} = \frac{n ( {σ}_{n}^{2} + {μ}_{n}^{2} ) + {x}_{n + 1}^{2}}{n + 1} - {μ}_{n + 1}^{2} \qquad ( Expression 2 )$$

In Expression 1, “n” indicates the number of all target users before update, “μₙ” indicates an average of all target users before update with respect to one genre, and “xₙ₊₁” indicates a first item value of the genre of a new target user. In Expression 2, “σ²ₙ” indicates the variance of all target users before update with respect to one genre, and “μₙ₊₁” indicates the variance of all target users after update. The tendency information generation unit 35 calculates an average after update for each genre using Expression 1, and calculates a variance after update using Expression 2. In this way, the tendency information generation unit 35 updates the average and variance for each genre. Then, the tendency information generation unit 35 updates tendency information by generating each second item value of tendency information based on the normal distribution for each genre, which is represented by the average and variance after the update, in the same manner as the above-described method. The tendency information generation unit 35 stores, in the storage unit 31, information in which the updated tendency information and statistic are associated with the content identification information received from the acquisition unit 34.

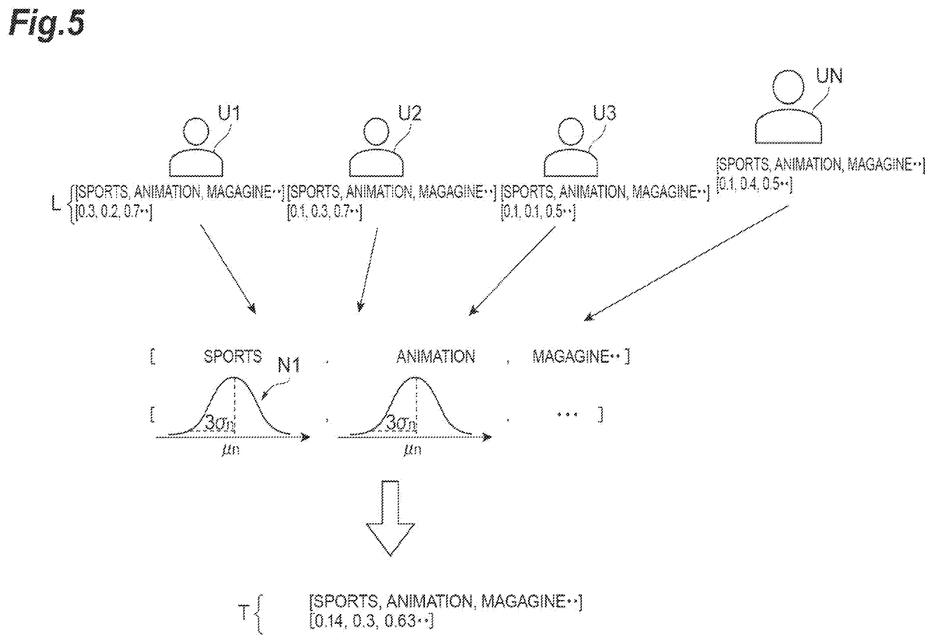

Hereinafter, an example of a method of updating the tendency information will be described using the example illustrated in FIG. 5. FIG. 5 is a schematic diagram showing a flow of updating tendency information by the information processing device 30. First, the extraction unit 33 extracts a new target user UN who has used the content, and the acquisition unit 34 acquires the preference information L of the target user UN. Then, the tendency information generation unit 35 updates the tendency information T by calculating the second item value based on the normal distribution N1 represented by the average after update calculated by using Expression 1 and the variance after update calculated by using Expression 2 for each genre. In the example shown in FIG. 5, since the first item value of the genre “animation” of the target user UN is a relatively large value (0.4), the second item value of “animation” in the tendency information T after the update changes from “0.2” (see FIG. 2) to “0.3”. Since the preference information L of the new user is reflected in the tendency information T of the content every time the new user uses the content, the tendency information T of the content may be appropriately and timely updated.

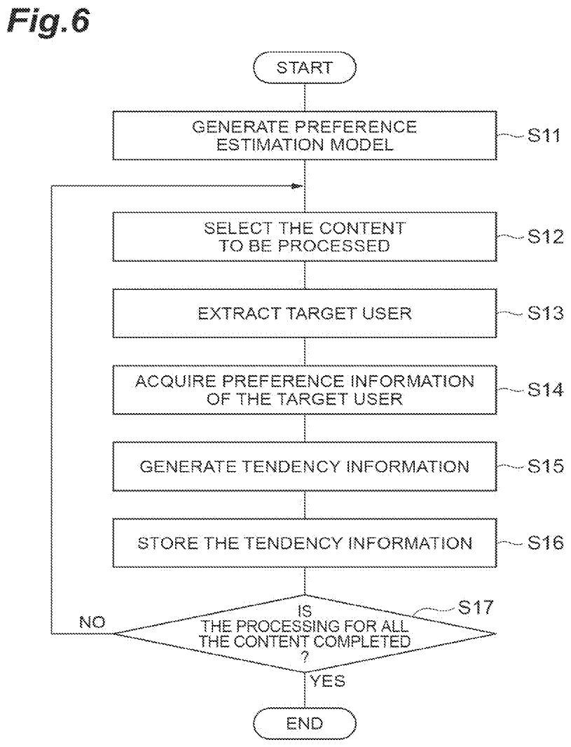

Next, an example of tendency information generation processing performed by the information processing device 30 will be described with reference to the flowchart shown in FIG. 6 and the example of FIG. 2. First, the model generation unit 32 generates a plurality of preference estimation models (first preference estimation model M1, second preference estimation model M2, third preference estimation model M3, or the like) corresponding to each of a plurality of predetermined genres by performing machine learning using the training data described above (step S11). Subsequently, the extraction unit 33 selects the content to be processed, for example, at a preset timing (step S12), and extracts the target users U1, U2, and U3 who have used the content to be processed by referring to the usage information stored in the content delivery server 10 (step S13). The extraction unit 33 outputs information in which the identification information of each of the extracted target user U1, U2, and U3 is associated with the identification information of the content to be processed to the acquisition unit 34.

Subsequently, the acquisition unit 34 acquires the preference information L of the target user extracted by the extraction unit 33 (step S14). More specifically, the acquisition unit 34 refers to the identification information of the target users U1, U2, and U3 received from the extraction unit 33, and inputs the attribute information of the target users U1, U2, and U3 (more specifically, the basic information and usage information of the target users U1, U2, and U3 stored in the content delivery server 10 and the usage information of the target users U1, U2, and U3 stored in the service server 20) to the preference estimation models M1, M2, and M3 stored in the storage unit 31. Then, the acquisition unit 34 acquires the first item values of each genre output from each preference estimation model M1, M2, and M3 as the preference information L of the target users U1, U2, and U3. The acquisition unit 34 outputs information in which the acquired preference information L of each target user U1, U2, and U3 is associated with the content identification information received from the extraction unit 33 to the tendency information generation unit 35.

Subsequently, the tendency information generation unit 35 generates the tendency information T of the content based on the preference information L of each target user U1, U2, and U3 acquired by the acquisition unit 34 (step S15). Specifically, the tendency information generation unit 35 generates the tendency information T by statistically processing the first item values of each target user U1, U2, and U3 for each genre (in the present embodiment, by generating the second item values of each genre based on the calculated normal distribution N1).

Subsequently, the tendency information generation unit 35 stores the generated tendency information T in the storage unit 31 (step S16). More specifically, the tendency information generation unit 35 stores, in the storage unit 31, information in which the tendency information T, content identification information, and statistics (Specifically, the calculated average and variance, and the numbers of all target users U1, U2, and U3) are associated with each other.

The processing of steps S12 to S16 described above is executed for each content until the processing for all the content is completed (step S17: NO). When the processing of steps S12 to S16 is completed for all the content (step S17: YES), the information processing device 30 ends the tendency information generation processing.

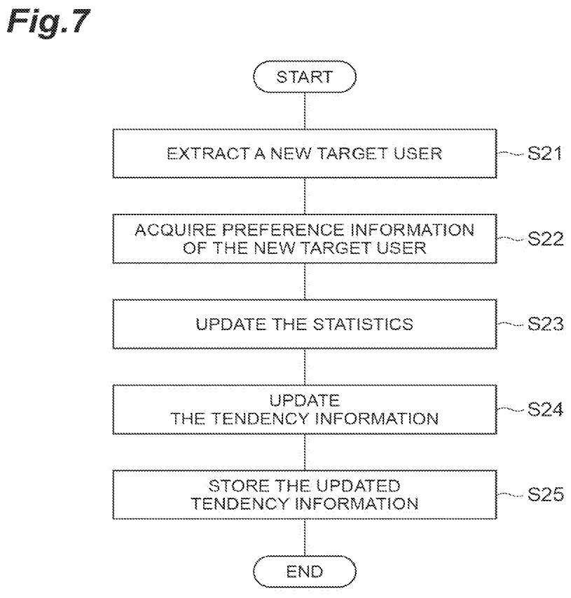

Next, an example of tendency information update processing performed by the information processing device 30 will be described with reference to the flowchart shown in FIG. 7 and the example of FIG. 5. First, the extraction unit 33 extracts a new target user UN using a certain content (step S21). The extraction unit 33 outputs information in which identification information of the new target user UN and identification information of the content are associated with each other to the acquisition unit 34.

Subsequently, the acquisition unit 34 acquires the preference information L of the new target user UN (step S22). Then, the acquisition unit 34 outputs information in which the preference information L of the acquired new target user UN is associated with the content identification information received from the extraction unit 33 to the tendency information generation unit 35.

Subsequently, the tendency information generation unit 35 updates the statistics of the content based on the preference information L of the new target user UN acquired by the acquisition unit 34 and the statistics (average μₙ and variance σ²ₙ before update) stored in the storage unit 31 (step S23). More specifically, the tendency information generation unit 35 calculates the average μₙ₊₁ and the variance σ²ₙ₊₁ in which the preference information L of the new target user UN is reflected by using the average update function (Expression 1) and the variance update function (Expression 2) described above.

Subsequently, the tendency information generation unit 35 updates the tendency information T of the content based on the updated average μₙ₊₁ and variance σ²ₙ₊₁ (step S24). More specifically, the tendency information generation unit 35 generates each second item value of the tendency information T based on the normal distribution N1 represented by the updated average μₙ₊₁ and variance σ²ₙ₊₁. In this way, the tendency information generation unit 35 updates the tendency information T of the content. Subsequently, the tendency information generation unit 35 stores information in which the updated tendency information T and statistic are associated with the content identification information in the storage unit 31 (step S25).

In the information processing device 30 described above, in a content delivery service that provides content to a user, a target user that is a user using the content is extracted, preference information related to a preference of the extracted target user and including a plurality of first item values (item values) related to a predetermined preference is acquired, and tendency information indicating a tendency of the content is generated based on the acquired preference information of the target user. According to the above configuration, the tendency information indicating the tendency of the content is generated by reflecting the plurality of first item values related to the preference of the user using the content, and thus it is possible to assign a unified score to each of the plurality of content.

Conventionally, the type of meta data associated with each content by a service provider such as a communication provider is usually different depending on the type of service, the type of content, and the like. Here, such content are common in that they are “used by the user”. Therefore, in the information processing device 30, tendency information indicating which user (that is, a user who prefers which genre) is likely to use the content is generated based on preference information of the target user, and thus it is possible to give a unified score beyond differences in the type of content, the type of service, and the like. As described above, the unified score for each piece of content can be used for, for example, analysis of content using XAI or the like, advanced recommendation of content to a user, online recommendation, or the like.

Each first item value is a numerical value indicating the degree of preference of the target user with respect to each predetermined genre related to the content, and when a plurality of target users are extracted by the extraction unit 33, the tendency information generation unit 35 generates tendency information by statistically processing the first item value of each target user for each genre. According to the information processing device 30, since the statistical value (second item value) of the degree of preference of a plurality of target users is obtained with respect to each genre determined in advance, it is possible to obtain tendency information indicating what kind of users who have certain favorite genre are likely to use the content.

The tendency information generation unit 35 calculates an average μₙ and a variance σ²ₙ of first item values of each target user for each genre, generates a normal distribution based on the calculated average μₙ and variance σ²ₙ for each genre, and generates tendency information based on the generated normal distribution of each genre. According to the above configuration, it is possible to obtain tendency information in which statistical results of characteristics (tendencies of preferred genres) of a plurality of target users are appropriately reflected.

The model generation unit 32 generates preference estimation models (including first preference estimation model M1, second preference estimation model M2, and third preference estimation model M3) for each of a plurality of genres by performing machine learning using training data including attribute information of a user (e.g., basic information of the user and usage information of one or more services used by the user) and an index value (information indicating preference) of the user. According to the above configuration, the preference estimation model that receives the attribute information of the target user as an input and outputs the estimated value of the preference information is constructed for each genre, and the preference information is acquired using the preference estimation model, so that the preference information of the target user can be obtained efficiently and accurately.

The attribute information of the target user includes usage information of the target user related to the other service (a service different from the content delivery service). According to the above configuration, it is possible to accurately acquire not only the preference information of the target user who uses the content delivery service for a long period of time but also the preference information of the target user whose use history of the content delivery service is shallow.

The extraction unit 33 extracts a new target user (new user) every time the content is used by the new user, the acquisition unit 34 acquires the preference information of the extracted new target user, and the tendency information generation unit 35 updates the tendency information based on the preference information of the new target user. According to the above configuration, the tendency information is updated in real time, and thus it is possible to appropriately and timely obtain tendency information in which a change in popularity of content, a change in preference of all users using the content delivery service, and the like are reflected. In particular, according to the information processing device 30, since each second item value is updated using the average update function and the variance update function, it is possible to simplify the update of tendency information.

Note that the information processing device 30 may not include the model generation unit 32. In this case, the plurality of preference estimation models may be stored in the storage unit 31 in advance, or may be stored in a server or the like different from the information processing device 30. The preference information may be generated by a method different from a method using a model generated by machine learning, and may be stored in advance in a server or the like different from the information processing device 30.

Further, in the present embodiment, in the tendency information T, the value of the random number obtained from the normal distribution N1 of each genre is adopted as the second item value of each genre, but the second item value of each genre is not limited to the value of the random number. For example, the average μₙ of the first item values of each genre may be used as the second item value of each genre.

The block diagrams used in the description of the embodiment show blocks in units of functions. These functional blocks (components) are realized in any combination of at least one of hardware and software. Further, a method of realizing each functional block is not particularly limited. That is, each functional block may be realized using one physically or logically coupled device, or may be realized by connecting two or more physically or logically separated devices directly or indirectly (for example, using a wired scheme, a wireless scheme, or the like) and using such a plurality of devices. The functional block may be realized by combining the one device or the plurality of devices with software.

The functions include judging, deciding, determining, calculating, computing, processing, deriving, investigating, searching, confirming, receiving, transmitting, outputting, accessing, resolving, selecting, choosing, establishing, comparing, assuming, expecting, regarding, broadcasting, notifying, communicating, forwarding, configuring, reconfiguring, allocating, mapping, assigning, or the like, but not limited thereto.

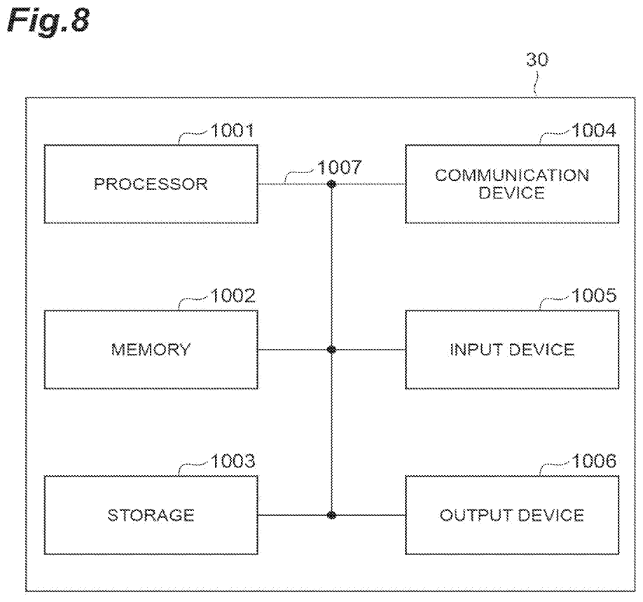

For example, the information processing device 30 according to an embodiment of the present invention may function as a computer that performs an information processing method of the present disclosure. FIG. 8 is a diagram illustrating an example of a hardware configuration of the information processing device 30 according to the embodiment of the present disclosure. The information processing device 30 described above may be physically configured as a computer device including a processor 1001, a memory 1002, a storage 1003, a communication device 1004, an input device 1005, an output device 1006, a bus 1007, and the like. The hardware configuration of the content delivery server 10 and the service server 20 described above may be configured as a computer device similar to the information processing apparatus 30.

In the following description, the term “device” can be referred to as a circuit, a device, a unit, or the like. The hardware configuration of the information processing device 30 may include one or a plurality of devices illustrated in FIG. 8, or may be configured without including some of the devices.

Each function in the information processing device 30 is realized by loading predetermined software (a program) into hardware such as the processor 1001 or the memory 1002 so that the processor 1001 performs computation to control communication that is performed by the communication device 1004 or control at least one of reading and writing of data in the memory 1002 and the storage 1003.

The processor 1001, for example, operates an operating system to control the entire computer. The processor 1001 may be configured as a central processing unit (CPU) including an interface with peripheral devices, a control device, a computation device, a register, and the like.

Further, the processor 1001 reads a program (program code), a software module, data, or the like from at one of the storage 1003 and the communication device 1004 into the memory 1002 and executes various processes according to the program, the software module, the data, or the like. As the program, a program for causing the computer to execute at least some of the operations described in the above-described embodiment may be used. For example, the tendency information generation unit 35 may be realized by a control program that is stored in the memory 1002 and operated on the processor 1001, and other functional blocks may be realized similarly. Although the case in which the various processes described above are executed by one processor 1001 has been described, the processes may be executed simultaneously or sequentially by two or more processors 1001. The processor 1001 may be realized using one or more chips. The program may be transmitted from a network via an electric communication line.

The memory 1002 is a computer-readable recording medium and may be configured of, for example, at least one of a read only memory (ROM), an erasable programmable ROM (EPROM), an electrically erasable programmable ROM (EEPROM), and a random access memory (RAM). The memory 1002 may be referred to as a register, a cache, a main memory (a main storage device), or the like. The memory 1002 can store an executable program (program code), software modules, and the like in order to implement the communication control method according to the embodiment of the present disclosure.

The storage 1003 is a computer-readable recording medium and may also be configured of, for example, at least one of an optical disc such as a compact disc ROM (CD-ROM), a hard disk drive, a flexible disc, a magneto-optical disc (for example, a compact disc, a digital versatile disc, or a Blu-ray (registered trademark) disc), a smart card, a flash memory (for example, a card, a stick, or a key drive), a floppy (registered trademark) disk, a magnetic strip, and the like. The storage 1003 may be referred to as an auxiliary storage device. The storage medium described above may be, for example, a database including at least one of the memory 1002 and the storage 1003, a server, or another appropriate medium.

The communication device 1004 is hardware (a transmission and reception device) for performing communication between computers via at least one of a wired network and a wireless network and is also referred to as a network device, a network controller, a network card, or a communication module, for example.

The input device 1005 is an input device (for example, a keyboard, a mouse, a microphone, a switch, a button, or a sensor) that receives an input from the outside. The output device 1006 is an output device (for example, a display, a speaker, or an LED lamp) that performs output to the outside. The input device 1005 and the output device 1006 may have an integrated configuration (for example, a touch panel).

Further, the respective devices such as the processor 1001 and the memory 1002 are connected by the bus 1007 for information communication. The bus 1007 may be configured using a single bus or may be configured using buses different between the devices.

Further, the information processing device 30 may include hardware such as a microprocessor, a digital signal processor (DSP), an application specific integrated circuit (ASIC), a programmable logic device (PLD), or a field programmable gate array (FPGA), and some or all of the functional blocks may be realized by the hardware. For example, the processor 1001 may be implemented by at least one of these pieces of hardware.

Although the present embodiment has been described in detail above, it is apparent to those skilled in the art that the present embodiment is not limited to the embodiments described in the present disclosure. The present embodiment can be implemented as a modification and change aspect without departing from the spirit and scope of the present invention determined by description of the claims. Accordingly, the description of the present disclosure is intended for the purpose of illustration and does not have any restrictive meaning with respect to the present embodiment.

A process procedure, a sequence, a flowchart, and the like in each aspect/embodiment described in the present disclosure may be in a different order unless inconsistency arises. For example, for the method described in the present disclosure, elements of various steps are presented in an exemplified order, and the elements are not limited to the presented specific order.

Input or output information or the like may be stored in a specific place (for example, a memory) or may be managed in a management table. Information or the like to be input or output can be overwritten, updated, or additionally written. Output information or the like may be deleted. Input information or the like may be transmitted to another device.

A determination may be performed using a value (0 or 1) represented by one bit, may be performed using a Boolean value (true or false), or may be performed through a numerical value comparison (for example, comparison with a predetermined value).

Each aspect/embodiment described in the present disclosure may be used alone, may be used in combination, or may be used by being switched according to the execution. Further, a notification of predetermined information (for example, a notification of “being X”) is not limited to be made explicitly, and may be made implicitly (for example, a notification of the predetermined information is not made).

Software should be construed widely so that the software means an instruction, an instruction set, a code, a code segment, a program code, a program, a sub-program, a software module, an application, a software application, a software package, a routine, a sub-routine, an object, an executable file, a thread of execution, a procedure, a function, and the like regardless whether the software is called software, firmware, middleware, microcode, or hardware description language or called another name.

Further, software, instructions, information, and the like may be transmitted and received via a transmission medium. For example, when software is transmitted from a website, a server, or another remote source using wired technology (a coaxial cable, an optical fiber cable, a twisted pair, a digital subscriber line (DSL), or the like) and wireless technology (infrared rays, microwaves, or the like), at least one of the wired technology and the wireless technology is included in a definition of the transmission medium.

The information, signals, and the like described in the present disclosure may be represented using any of various different technologies. For example, data, an instruction, a command, information, a signal, a bit, a symbol, a chip, and the like that can be referred to throughout the above description may be represented by a voltage, a current, an electromagnetic wave, a magnetic field or a magnetic particle, an optical field or a photon, or an arbitrary combination of them.

Further, the information, parameters, and the like described in the present disclosure may be expressed using an absolute value, may be expressed using a relative value from a predetermined value, or may be expressed using another corresponding information.

Names used for the above-described parameters are not limited names in any way. Further, equations or the like using these parameters may be different from those explicitly disclosed in the present disclosure.

Since various information elements can be identified by any suitable names, the various names assigned to these various information elements are not limited names in any way.

The description “based on” used in the present disclosure does not mean “based only on” unless otherwise noted. In other words, the description “based on” means both of “based only on” and “based at least on”.

Any reference to elements using designations such as “first,” “second,” or the like used in the present disclosure does not generally limit the quantity or order of those elements. These designations may be used in the present disclosure as a convenient way for distinguishing between two or more elements. Thus, the reference to the first and second elements does not mean that only two elements can be adopted there or that the first element has to precede the second element in some way.

When “include”, “including” and transformation of them are used in the present disclosure, these terms are intended to be comprehensive like the term “comprising”. Further, the term “or” used in the present disclosure is intended not to be exclusive OR.

In the present disclosure, for example, when articles such as “a”, “an”, and “the” in English are added by translation, the present disclosure may include that nouns following these articles are plural.

In the present disclosure, a sentence “A and B are different” may mean that “A and B are different from each other”. The sentence may mean that “each of A and B is different from C”. Terms such as “separate”, “coupled”, and the like may also be interpreted, similar to “different”.

### REFERENCE SIGNS LIST

30 information processing device
32 model generation unit
33 extraction unit
34 acquisition unit
35 tendency information generation unit
M1 first preference estimation model (preference estimation model)
M2 second preference estimation model (preference estimation model)
M3 third preference estimation model (preference estimation model)
L preference information
T tendency information,
U1 to U3 target user
UN target user (new user).

1. An information processing device, comprising:
an extraction unit configured to extract a target user that is a user who has used content in a content delivery service providing the content to the user;
an acquisition unit configured to acquire preference information related to a preference of the target user extracted by the extraction unit, the preference information including a plurality of item values related to a predetermined preference; and
a tendency information generation unit configured to generate tendency information indicating a tendency of the content based on the preference information of the target user acquired by the acquisition unit.

2. The information processing device according to claim 1, wherein
each of the plurality of item values is a numerical value indicating a degree of preference of the target user for each of a plurality of predetermined genres related to content, and
when a plurality of target users are extracted by the extraction unit, the tendency information generation unit generates the tendency information by statistically processing the item value of each of the plurality of target users for each genre.

3. The information processing device according to claim 2, wherein
the tendency information generation unit is configured to:
calculate, for each of the plurality of genres, an average and a variance of the item values of each of the plurality of target users;
generate a normal distribution for each of the plurality of genres based on the calculated average and variance; and
generate the tendency information based on the generated normal distribution of each of the plurality of genres.

4. The information processing device according to claim 1, further comprising:
a model generation unit configured to execute machine learning using training data including attribute information of a user and information indicating a preference of the user to generate a preference estimation model that inputs the attribute information of the user and outputs an estimated value of the preference information of the user, wherein
the acquisition unit is configured to acquire an output result from the preference estimation model as the preference information of the target user by inputting the attribute information of the target user to the preference estimation model.

5. The information processing device according to claim 4, wherein
the attribute information of the target user includes usage information of the target user related to a service different from the content delivery service.

6. The information processing device according to claim 1, wherein
the extraction unit is configured to extract a new user every time the content is used by the new user,
the acquisition unit is configured to acquire the preference information of the extracted new user, and
the tendency information generation unit is configured to update the tendency information based on the preference information of the new user.
